(19) United States
(12) Patent Application Publication
(10) Pub. No.: US 2011/0321073 A1
(43) Pub. Date: Dec. 29, 2011

(54) TECHNIQUES FOR CUSTOMIZATION

(76) Inventors: Mark D. Yarvis, Portland, OR (US); Sharad K. Garg, Portland, OR (US); Rita H. Wouhaybi, Portland, OR (US); Chieh-Yih Wan, Beaverton, OR (US)

(21) Appl. No.: 12/821,376

(22) Filed: Jun. 23, 2010

(51) Int. Cl. H04H 60/33

(52) U.S. Cl. 725/10

(57) ABSTRACT

Techniques are disclosed that involve detecting and tracking groups of people associated with a user device (e.g., people watching television), and customizing the experience to the group. Various features may be employed. Such features may include classification of individuals, identification of commonly occurring groupings of people, and identification of the presence of group outsiders. Based on the presence of such individuals, groups, and/or outsiders, delivery of information to the user device may be controlled.

### BACKGROUND

Personalization is becoming increasingly important in the delivery of content. For instance, devices, (e.g., personal computers, mobile devices, set-top-boxes, televisions, etc.) can be personalized to the specific person using it.

This personalization may involve customizing the device's user interface in terms of what information is presented, how information is organized, what services are available, and what language is used. Also, with this personalization, content and advertisements can be prioritized, selected, and targeted to that person's interests. Typically, personalization is applied to an individual.

However, devices such as televisions are often used by a group of people, rather than an individual. Examples of such groups include families, groups of friends, children, and, parents. Customizing techniques are not currently based on the presence of such groups.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an exemplary operational environment;

FIG. 2 is a diagram of an exemplary implementation;

FIG. 3 is a diagram of an exemplary implementation within a processing module; and

FIG. 4 is a logic flow diagram.

### DETAILED DESCRIPTION

Embodiments provide techniques that involve detecting and tracking groups of people associated with a user device (e.g., people watching television), and customizing the experience to the group. Various features may be employed. Such features may include classification of individuals, identification of commonly occurring groupings of people, and identification of the presence of group outsiders. Based on the presence of such individuals, groups, and/or outsiders, delivery of information to the user device may be controlled.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Operations for the embodiments may be further described with reference to the following figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

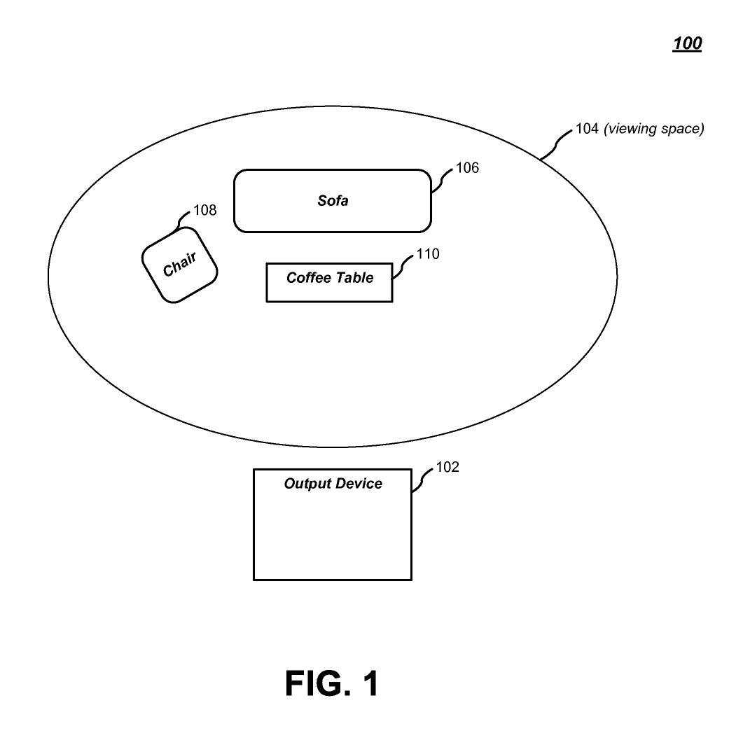

FIG. 1 is a diagram showing an overhead view of an exemplary operational environment 100. Operational environment 100 may be in various locations. Exemplary locations include one or more rooms within a home, space(s) within a business or institution, and so forth.

As shown in FIG. 1, operational environment 100 includes an output device 102. Output device 102 may be of various device types that provide visual and/or audiovisual output to one or more users. For example, in embodiments, output device 102 may be a television, a personal computer, or other suitable device.

FIG. 1 shows a viewing space 104. Within viewing space 104, one or more persons are able to receive information and/or services that are output by device 102. Various static objects exist within viewing space 104. In particular, FIG. 1 shows a sofa 106, a chair 108, and a coffee table 110. These objects are shown for purposes of illustration, and not limitation. Persons may also be within viewing space 104. For example, within a period of time, one or more persons may enter and/or leave viewing space 104.

Thus, at any given moment in time, there may be any number of persons (zero or more persons) within viewing space 104. Moreover, each person may fit within various classification categories. Exemplary classifications include (but are not limited to) child, adult, female, and male. Also, such persons may form predetermined groups or clusters of individuals, as well as variants (e.g., subsets) of such groups. Additionally, such persons may include outsiders to such clusters.

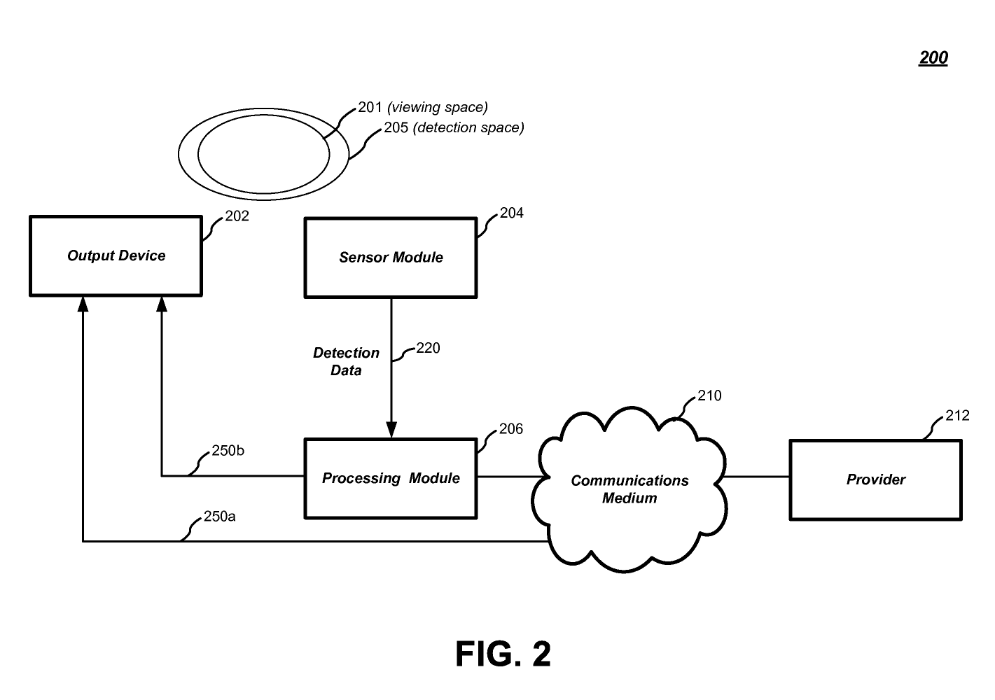

FIG. 2 is a diagram of an exemplary implementation 200 that may be employed in embodiments. Implementation 200 may include various elements. For instance, FIG. 2 shows implementation 200 including an output device 202, a sensor module 204, and a processing module 206. These elements may be implemented in any combination of hardware and/or software.

Output device 202 provides audio, visual and/or audiovisual output associated with services and/or information (e.g., content and/or advertising). Exemplary output includes audio, video and/or graphics. Thus, in embodiments, output device 202 may be a television, a personal computer, a mobile device (e.g., mobile phone, personal digital assistant, mobile Internet device, etc.), or other suitable device. This output may be viewed by one or more persons within a viewing space 201. Viewing space 201 may be like or similar to viewing space 104 of FIG. 1. Embodiments, however, are not limited to this context.

Sensor module 204 collects information regarding a detection space 205. Detection space 205 may correspond to viewing space 201. For instance, detection space 205 may be within, encompass or partially overlap viewing space 201. Embodiments, however, are not limited to these examples. For purposes of illustration, FIG. 2 shows detection space 205 encompassing viewing space 201. Based on this collected information, sensor module 204 generates corresponding detection data 220.

Sensor module 204 may include one or more sensors and/or devices. For instance, sensor module 204 may include one or more cameras. Such camera(s) may include a visible light camera. Alternatively or additionally, such camera(s) may include a thermal or infrared camera that encodes heat variations in color data. The employment of such cameras allow persons within detection space 205 to be characterized (e.g., by number, gender, and/or age) with various pattern recognition techniques. Also, such techniques may be employed to identify particular individuals through the recognition of their previously registered faces.

In embodiments, sensor module 204 may include one or more wireless devices that identify persons within detection space 205 through their personal devices. For example, sensor module 204 may include a radio frequency identification (RFID) reader that identifies persons by their RFID tags (e.g., RFID tags worn by persons).

Also, sensor module 204 may include wireless communications devices that communicate with wireless user devices (e.g., personal digital assistants, mobile Internet devices, mobile phones, and so forth). Such wireless communications devices may employ various technologies, including (but are not limited to) Bluetooth, IEEE 802.11, IEEE 802.16, long term evolution (LTE), wireless gigabit (WiGIG), ultra wideband (UWB), Zigbee, wireless local area networks (WLANs), wireless personal area networks (WPANs), and cellular telephony.

Also, sensor module 204 may include microphones that receive sounds (speech and/or conversations between individuals) and generate corresponding audio signals. From such signals, persons may be characterized (e.g., by number, gender, and/or age). Also, particular persons may be recognized from such signals by matching them with previously registered voices.

Also, sensor module 204 may include remote controls for output device 202 or other personal devices. Such devices may identify a person by the way they utilize the device (e.g., using accelerometry to measure how the user handles the remote or sensing the way they press buttons on the device).

Also, sensor module 204 may include motion sensors that can detect and characterize a certain person's movements and patterns.

Thus, detection data 220 may provide information regarding individuals within detection space. This information may identify individuals. Alternatively or additionally, this information may include characteristics or features of individuals. Based on such determinations, features or characteristics, processing module 206 may identify and/or classify individuals. Moreover, processing module 206 may determine whether particular groups and/or outsiders are within detection space 205.

Based on such operations, processing module 206 may affect the delivery of services and information (e.g., content and advertising) to output device 202. For instance, application module 208 may control the availability (or unavailability) of various services and/or information.

As described herein, providers may originate information that is output by output device 202. As a non-limiting example, FIG. 2 shows a provider 212 that delivers information (e.g., services, content, and/or advertising) through a communications medium 210.

Embodiments may control the delivery of such information in various ways. For instance, in an upstream content control approach, processing module 206 may provide one or more providers (e.g., provider 212) with information (e.g., parameters and/or directives) regarding delivery. In turn, the provider(s) may deliver or refrain from delivering particular services and/or information to output device 202 based at least on this information.

Additionally or alternatively, in a localized control approach, processing module 206 may perform delivery and/or blocking. In such cases, processing module 208 may receive services and/or information from one or more providers and determine whether to provide such services and/or information to output device 202. According to this approach, processing module 206 may forward information and/or services to output device 202 “live”. Alternatively or additionally, processing module 206 may store information and/or services for later delivery to output device 202.

In accordance with such approaches, FIG. 2 shows delivery paths 250a and 250b. Delivery path 250a provides information and/or services directly from provider 212 to output device 202. This path may be employed with the aforementioned upstream control approach. In contrast, delivery path 250b provides processing module 206 as an intermediary between provider 212 and output device 202. This path may be employed with the aforementioned localized content control approach.

Communications medium 210 may include (but is not limited to) any combination of wired and/or wireless resources. For example, communications medium 210 may include resources provided by any combination of cable television networks, direct video broadcasting networks, satellite networks, cellular networks, wired telephony networks, wireless data networks, the Internet, and so forth.

Provider 212 may include any entities that can provide services and/or information (e.g., content and/or advertising) to user devices. Thus, provider 212 may include (but is not limited to) television broadcast stations, servers, peer-to-peer networking entities (e.g., peer devices), and so forth.

The elements of FIG. 2 may be arranged in various ways. For instance, exemplary arrangements involve processing module 206 and/or sensor module 204 being implemented in a user device, such as a set top box. In further exemplary arrangements, any combination of output device 202, sensor module 204, and/or processing module 206 may be implemented in a user device. As described herein, the elements of FIG. 2 may be implemented in any combination of hardware and/or software. Accordingly, exemplary implementations may include one or more processors and control logic (e.g., software instructions) that direct operations of the one or more processors. Such control logic may be stored in a tangible storage medium (e.g., memory, disk storage, etc.) Embodiments, however, are not limited to these examples.

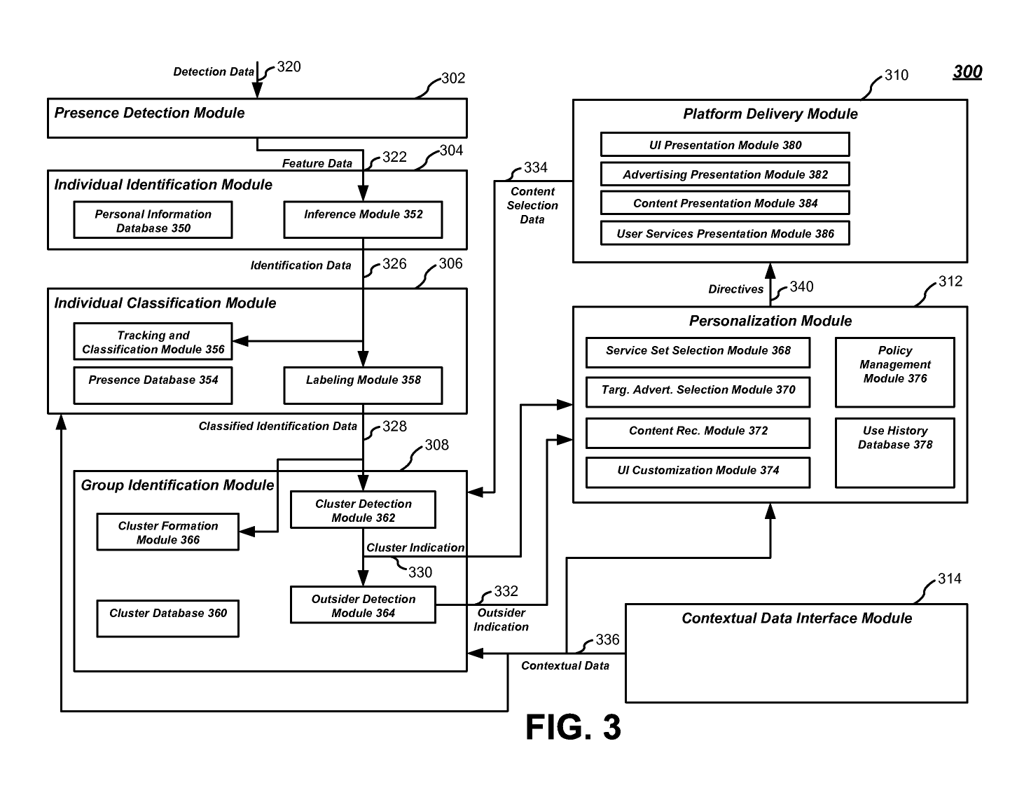

FIG. 3 is a diagram showing an exemplary implementation 300 of processing module 206. As shown in FIG. 3, implementation 300 includes a presence detection module 302, an individual identification module 304, an individual classification module 306, a group identification module 308, a platform delivery module 310, a personalization module 312, and a contextual data interface module 314. These elements may be implemented in any combination of hardware and/or software. Moreover, implementation 300 includes elements (e.g., database modules) that may store information. Thus, implementation 300 may include storage media (e.g., memory) to provide such storage features. Examples of storage media are provided below.

As shown in FIG. 3, implementation 300 receives detection data 320 regarding a detection space (such as detection space 205). This data may be received directly from one or more devices (such as sensor(s) within sensor module 204). Alternatively or additionally, this data may be received from a storage medium. Accordingly, detection data 320 may include information, such as camera images, audio signals, accelerometer measurements, and so forth. Also, detection data 320 may include identifiers that indicate particular individuals. Such identifiers may be in the form of wireless communications addresses (e.g., MAC addresses), RFID tag identifiers, and so forth.

From detection data 320, presence detection module 302 determines the presence of one or more individuals (if any) within the detection space. This may involve various signal/image processing and/or pattern recognition operations. In turn, presence detection module 302 generates feature data 322 for each detected individual. In embodiments, feature data 322 may convey one or more features (e.g., facial features, height, size, voice parameters, etc.) extracted through image/signal processing techniques. Additionally or alternatively, feature data 322 may include identifiers (e.g., communications device addresses, RFID tag identifiers, etc.) Embodiments are not limited to these examples.

Individual identification module 304 identifies such detected persons. This identification is based at least on feature data 322. In embodiments, this identification may involve matching features of detected persons with known features of individuals. Such known features may be stored within a personal information database 350. FIG. 3 shows that individual identification module 304 may include an inference module 352.

Inference module 352 includes control logic that makes statistical inferences (conclusions) based at least on feature data 322. Also, these inferences may be based on information stored in personal information database 350. These inferences result in the generation of identification data 326, which is sent to individual classification module 306. Identification data 326 includes one or more indicators, each indicating a person currently identified in the detection space.

Individual classification module 306 manages classifications of individuals identified by individual identification module 304. This may involve assigning new classifications, as well as updating existing classifications, for identified individuals. As shown in FIG. 3, individual classification module 306 includes a presence database 354, a tracking and classification module 356, and a labeling module 358.

Presence database 354 maintains classification information for multiple individuals. More particularly, for each of the individuals, presence database 354 stores corresponding classification metadata. This metadata indicates an individual's classification. As described above, exemplary classifications include child, adult, female, and male. Further examples are provided in the following table.

| Classification | Description |
|---|---|
| Family | Someone who is present often, |
| | and both day and night |
| Visiting family member | Someone who is not part of the |
| | regular family, but is living in |
| | the household for extended |
| | period of time. |
| Friend | Someone who is present |
| | frequently, but not every day, |
| | and usually not late at night. |
| Visitor | Someone who is present less |
| | often. |
| Stranger | Someone never seen before or |
| | seen extremely rarely. |

Also, presence database 354 maintains historical data regarding each of the individuals. For example, presence database 354 stores each identification of a particular individual. This may involve storing contextual information. Exemplary contextual information includes (but is not limited to) time of identification, other individuals identified with the particular individual, corresponding content viewing and selection(s) of the particular individual, and so forth. In embodiments, various contextual information may be received from contextual data interface module 314 as contextual data 336.

Tracking and classification module 356 assigns and updates classifications of individuals. FIG. 3 shows that tracking and classification module 356 receives identification data 326. As described above, identification data 326 indicates each person currently identified in the detection space. For each of these identifiers, tracking and classification module provides an update to presence database 354. This involves updating the historical data for the corresponding individual(s) in presence database 354.

Also, for each person indicated in identification data 326, tracking and classification module 356 performs classification operations to assign or update the person's classification. These classification operations involve determining a classification based on one or more factors. These factors may include (but are not limited to) any individuals currently identified with the person, current content selection(s), and historical data regarding the individual (e.g., data stored within presence database 354).

Further, the classification may be determined based on a consultation with a user via a user interface (e.g. through platform delivery module 310). For example, a user may be queried to classify an identified person. Examples of such queries are provided below.
“I've seen Joe very often, is he a friend?”
“I've seen Joe lately, is he a friend?”
“Please indicate which category in which Joe should be classified: friend, family . . . none.”

Upon determining a classification for an individual, tracking and classification module 356 stores the classification (e.g., updates the classification) in presence database 354.

As shown in FIG. 3, identification data 326 is further forwarded to labeling module 358. For individual(s) indicated in identification data 326, labeling module 358 retrieves corresponding classification(s) from presence database 354. In turn, labeling module 358 includes the classification(s) in identification data. This produces classified identification data 328, which is sent to group identification module 308.

Group identification module 308 performs operations involving groupings of individuals (also referred to herein as clusters). As shown in FIG. 3, group identification module 308 includes a cluster database 360, a cluster detection module 362, an outsider detection module 364, and a cluster formation module 366.

Cluster database 360 stores sets or lists of individuals (clusters) that are often in the detection space together. Moreover, for each cluster, cluster database 360 may store corresponding contextual information. Examples of such contextual information are provided below.

Cluster detection module 362 determines whether a cluster (e.g., as defined by cluster database 360) is currently present in the detection space. FIG. 3 shows that cluster detection module 362 receives classified identification data 328. Based on this data, cluster detection module 362 determines whether any clusters (or cluster variants) are present. This determination may involve accessing cluster database 360 and comparing the individuals in data 328 with the clusters stored therein. From this, cluster detection module 362 may indicate a detected cluster in a cluster indication 330.

Outsider detection module 364 determines whether non-cluster members are present in combination with a cluster. More particularly, outsider detection module 363 may determine whether data 328 indicates people outside of a cluster that is identified in cluster indication 330. If so, the outsider detection module 364 identifies such person(s) in an outsider indication 332.

Cluster formation module 366 may identify the appearance (and frequency of appearance) of potentially new clusters. Also, cluster formation module 366 may modify existing clusters. This may be based on classified identification data 328, cluster indication 330, and/or outsider indication 332.

Cluster formation module 366 may form new clusters upon noticing the occurrence of individuals in groups. For instance, cluster formation module 308 may form a new cluster when such a grouping of individuals indicated by data 328 (that doesn't result in a cluster identification by cluster detection module 362) occurs at a particular frequency or regularity. When forming a new cluster, cluster formation module 308 may direct cluster database 360 to store a corresponding cluster definition.

Modifying an existing cluster involves changing the individuals associated with the cluster. Cluster formation module 308 may update a cluster when a variation in a cluster (e.g., the existence additional and/or omitted individuals) occurs at a particular frequency or regularity When cluster formation module 366 identifies the occurrence of such conditions, it may modify a corresponding cluster definition in cluster database 360 or create a new cluster definition in cluster database 360.

Cluster operations (e.g., the identification of clusters, the formation of new clusters, and/or the modification of existing clusters) may be further based on contextual information. Such contextual information may pertain to events that coincide (or are proximate in time) with such operations.

Examples of contextual information include (but are not limited to) the day and time, personal calendar appointments (e.g., a birthday party), global calendar appointments (e.g., a holiday), and a TV schedule. Further, contextual information may include content selections associated with the group. For example, if five males get together on Friday evenings and view a football game, this group may be identified as a “football buddies” cluster associated with football or sporting events.

As shown in FIG. 3, group identification module 308 may receive such contextual information from platform delivery module 310 (as content selection data 334) and from contextual data interface module 314 (as contextual data 336). Content selection data 334 indicates current content selection(s) by user(s). Contextual data 336 may indicate associated events, such as current day and time, calendar events, and so forth. Embodiments, however, are not limited to these examples.

Thus, the identification of clusters, as well as the identification of cluster variants (e.g., subsets/supersets/combinations of clusters and their variants) may be aided by contextual information. Moreover, clusters may be advantageously formed more quickly, with greater confidence, and be given a semantic meaning.

Personalization module 312 directs platform delivery module 310 to provide a customized user experience. In embodiments, this customization is based on identified clusters, outsiders, and/or individual cluster members. Also, this customization may be based on specific policies set by one or more users, contextual data, and/or usage history. As shown in FIG. 3, personalization module 312 may include a service set selection module 368, a targeted advertising selection module 370, a content recommendation module 372, a user interface customization module 374, a policy management module 376, and a usage history database 378.

Service set selection module 368 determines the availability of services through a user device (e.g., output device 202). As described herein, exemplary services include (but are not limited to) shopping, banking, information (e.g., weather and news), and/or home automation. For example, when the adults of a household are alone in the detection space (e.g., when cluster indication 330 indicates the cluster “parents”, and outsider indication 332 does not indicate anyone else), service set selection module 368 may make all services available. However, when children are present (e.g., when cluster indication 330 indicates the cluster “whole family” and/or outsider indication 332 indicates the presence of one or more children), a limited number of services may be available.

Targeted advertising selection module 370 selects particular advertising to be delivered to users through the output device. Content recommendation module 372 makes one or more content recommendations. Thus, through modules 370 and 372, content and advertising can be targeted to the group present. For example, if the “football buddies” is present, sports oriented advertising and content may be presented/recommended. This may occur regardless of whether they are currently watching football. Thus, this feature is different from current advertising practices, which are typically bound to currently viewed content. Moreover, such selections and recommendations may be further refined when outsiders are present. For example, when children are present as outsiders, content depicting “cage fighting” may not be recommended and ads for alcohol-related products may not be selected.

User interface customization module 374 determines one or more characteristics in which a user may interact with the output device. For example, when a “whole family” cluster is present, a user interface (e.g., a graphical user interface) may be arranged to make family-friendly features more prominent and accessible. For instance, picture-oriented interfaces may be provided. Also, some features (e.g., a subset of news, banking functions, content channels not intended for children, and a subset of home automation functions) may be password protected. However, when only adults are present (e.g., when only a “parents cluster” is identified), then the user interface may be presented in a more streamlined manner.

As described above, modules 368-374 make various selections, determinations, and/or recommendations. In turn, these are provided to platform delivery module 310 as directives 340. In accordance with these directives, platform delivery module 310 provides for the exchange of information with a user device (e.g., output device 202).

The selections, determinations, and/or recommendations made by modules 368-374 may be based on various factors. For instance, each module's actions may be based on individual(s), cluster(s) and/or outsider(s) that are within the detection space (e.g., as identified in indicators 328, 330, and/or 332). Also, such actions may be made in accordance with user preferences. Moreover, such actions may be based on contextual data (e.g., received as contextual data 336). Also, such actions may be in accordance with policy guidelines received from policy management module 376. Further, such actions may be based on usage history data received from usage history database 378.

Policy management module 376 maintains various policies regarding the availability of services and information (e.g., content, advertising, etc.) to users. In embodiments, these policies may be established by authorized users. For example, these policies may include one or more blocking profiles. Such profile(s) may identify particular channels, content, and/or services to be blocked. Each blocking profile may correspond to particular individual(s), clusters, and/or outsider(s). For example, blocking profiles may exist for clusters that include children. Also, blocking profiles may exist for situations in which particular outsiders (e.g., children, visiting adults, etc.) are identified.

As described herein, policy management module 376 sends policy guidelines to modules 368-374. These guidelines may indicate various operational rules. For example, policy guidelines may include blocking rules selected from one or more blocking profiles. In embodiments, policy management module 376 selects policy guidelines from one or more of its maintained policies. This selection may be based on any combination of indicators 328, 330 and/or 332.

Usage history database 378 maintains data regarding usage by clusters, outsiders, and/or individuals. For example, this data may indicate services and information (e.g., content and advertising) provided to particular clusters, outsiders, and/or individuals. Moreover, this data may indicate when such information and services were provided. As shown in FIG. 3, usage history database 378 may provide usage history data to modules 368-374. In embodiments, this data may be specific to particular individuals, clusters, and/or outsiders identified (e.g., as identified by indicators 328, 330, and/or 332).

Platform delivery module 310 provides for the exchange of information with a user device (such as output device 202). As shown in FIG. 3, platform delivery module 310 includes a user interface presentation module 380, an advertising presentation module 382, a content presentation module 384, and a user services presentation module 386.

User interface presentation module 380 manages characteristics of a user interface. Such characteristics may include (but are not limited to) providing control logic for one or more interface features, providing password protection, and so forth. Moreover, this may involve providing user interfaces for services managed by user services presentation module 386 and for content recommendations provided by content presentation module 384. This management is in accordance with directives received from user interface customization module 374 within personalization module 312.

Advertising presentation module 382 manages the presentation of advertising to the user device. In embodiments, this may involve filtering particular advertisements received from an upstream provider. Additionally or alternatively, this may involve sending particular advertising selection criteria to an upstream provider. Also, this may involve selecting one or more stored (locally or remote) advertisements for delivery to the user device. This management is in accordance with directives received from targeted advertising selection module 370 within personalization module 312.

User services presentation module 384 manages the services that are provided to the user device. This may involve accessing remote service providers (e.g., news, banking, web browsing, e-mail, etc.). Also, this may involve interacting with home automation elements (e.g., sensors, actuators, home automation control logic, etc.). This management is in accordance with directives received from service set selection module 368 within personalization module 312.

Content presentation module 386 manages the presentation of content to the user device. In additional, content presentation 386 manages the presentation of content recommendations to the user device. This may involve receiving content from remote content providers (e.g., broadcast television stations, and/or content servers). Also, this may involve accessing content that is stored (locally or remote) for delivery to the user device. This management is in accordance with directives received from content recommendation module 372 within personalization module 312.

As described herein, contextual data interface module 314 generates contextual data 336. Contextual data 336 may include various information. Exemplary information includes (but is not limited to) the day and time, personal calendar appointments (e.g., a birthday party, global calendar appointments (e.g., a holiday), and a TV schedule. Further, contextual information may include content selections (current or historic). In embodiments, contextual data interface module 314, may receive such information from various user applications and/or remote entities. For example, calendar appointments may be received from personal information management applications, and televisions schedules may be received from remote content providers. Embodiments, however, are not limited to these examples.

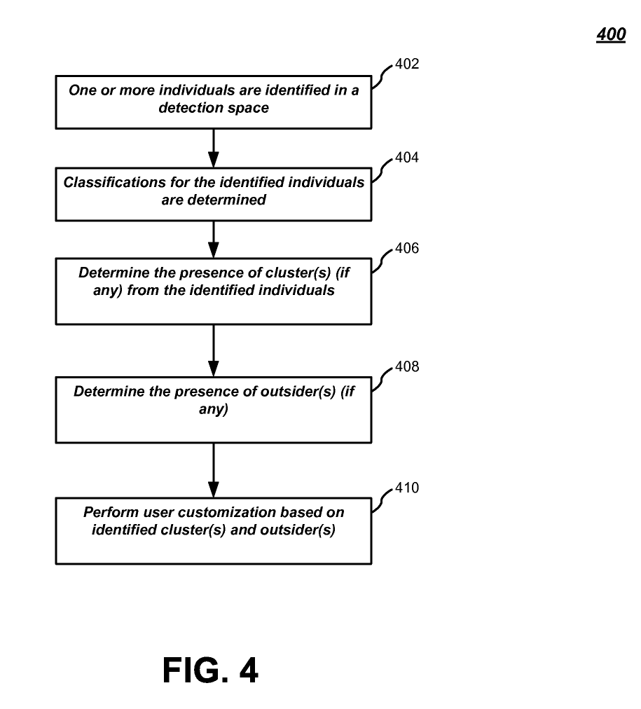

FIG. 4 illustrates an exemplary logic flow 400, which may be representative of operations executed by one or more embodiments described herein. Thus, this flow may be employed in the contexts of FIGS. 1-3. Embodiments, however, are not limited to these contexts. Also, although FIG. 4 shows particular sequences, other sequences may be employed. Moreover, the depicted operations may be performed in various parallel and/or sequential combinations.

At a block 402, one or more individuals are identified in a detection space. In embodiments, the detection space may correspond to a viewing space of an output device. An example of such correspondence is shown in FIG. 2. Embodiments, however, are not limited to this example.

At a block 404, classifications for each of the identified individuals are determined. In the context of FIG. 3, these classification(s) may be performed by individual classification module 306.

At a block 406, the presence of one or more clusters (if any) is determined. Also, at a block 408, the presence of one or more outsiders (if any) is determined. With reference to FIG. 3, the determination(s) of blocks 406 and 408 may be performed by group identification module 308.

At a block 410, user customization is performed. In embodiments, this customization is based on any cluster(s) and/or outsider(s) identified at blocks 404 and 406. Additionally, this customization may be based on any individuals identified and/or classified at blocks 402 and 404.

As described herein, this customization may involve targeting (e.g., selecting and/or blocking) the delivery of advertising to the output device. Also, this customization may involve selecting one or more content recommendations and outputting these recommendations through the output device. Further, this customization may involve setting user interface characteristics. Moreover, this customization may involve making services available (or unavailable) through the output device.

Thus, in the context of FIG. 3, various customization operations may be performed by personalization module 312 and platform delivery module 310. Embodiments, however, are not limited to this context.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

Some embodiments may be implemented, for example, using a storage medium or article which is machine readable. The storage medium may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software.

As described herein, embodiments may include storage media or machine-readable articles. These may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While various embodiments of the present invention have been described above, it should be understood that they have been presented by way of example only, and not in limitation.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method, comprising:
defining a cluster of individuals, the clusters corresponding to a group of individuals within viewing range of an output device;
determining the presence of the cluster within a detection space corresponding to the output device; and
controlling delivery of information to the output device based on the presence of the cluster.

2. The method of claim 1, further comprising:
determining the presence of one or more cluster outsiders within the detection space; and
controlling the delivery of information to the output device based on the presence of the cluster and the presence of the one or more outsiders.

3. The method of claim 1, wherein controlling the delivery of information includes targeting advertisements, content, and/or services to the output device.

4. The method of claim 1, wherein controlling the delivery of information includes providing one or more content recommendations.

5. The method of claim 1, wherein controlling the delivery of information includes establishing one or more user interface characteristics.

6. The method of claim 1, wherein controlling the delivery of information includes blocking information.

7. The method of claim 1, further comprising identifying one or more individuals in the detection space;
wherein said determining the presence of the cluster is based on the one more identified individuals.

8. The method of claim 7, wherein said identifying the one or more individuals is based on sensor data received from one or more sensors.

9. The method of claim 7, wherein said identifying the one or more individuals is based on information received from one or more wireless communications devices associated with the one or more individuals.

10. An apparatus, comprising:
a group identification module to determine the presence of a predefined cluster of individuals within a detection space corresponding to an output device; and
a platform delivery module to control the delivery of information to the output device based on the presence of the cluster.

11. The apparatus of claim 10, wherein the group identification module is to determine the presence of one or more cluster outsiders within the detection space; and
wherein the platform delivery module is to control the delivery of information to the output device based on the presence of the cluster and the presence of the one or more outsiders.

12. The apparatus of claim 10, further comprising a individual identification module to identify one or more individuals within the detection space;
wherein the group identification is to determine the presence of the cluster based on the one or more identified individuals.

13. The apparatus of claim 12, further comprising one or more sensors to generate sensor data;
wherein the individual identification module is to identify the one or more individuals based at least on the sensor data.

14. The apparatus of claim 12, wherein the individual identification module is to identify the one or more individuals based at least on information received from one or more wireless communications devices associated with the one or more individuals.

15. The apparatus of claim 10, wherein controlling the delivery of information includes targeting advertisements, content, and/or services to the output device.

16. The apparatus of claim 10, wherein controlling the delivery of information includes providing one or more content recommendations.

17. The apparatus of claim 10, wherein controlling the delivery of information includes establishing one or more user interface characteristics.

18. An article comprising a machine-accessible medium having stored thereon instructions that, when executed by a machine, cause the machine to:
define a cluster of individuals, the clusters corresponding to a group of individuals within viewing range of an output device;
determine the presence of the cluster within a detection space corresponding to the output device; and
control delivery of information to the output device based on the presence of the cluster.

19. The article of claim 18, wherein the instructions, when executed by a machine, cause the machine to:
determine the presence of one or more cluster outsiders within the detection space; and
control the delivery of information to the output device based on the presence of the cluster and the presence of the one or more outsiders.

20. The article of claim 18, wherein said determining the presence of the cluster is based on the one more identified individuals.
